(19) United States
(12) Patent Application Publication
(10) Pub. No.: US 2012/0080208 A1
(43) Pub. Date: Apr. 5, 2012

(54) PNEUMATIC MOTOR AND PNEUMATIC TOOL HAVING THE SAME

(75) Inventors: Tien LIN, Taichung County (TW); Yen-Che CHIANG, Taichung County (TW)

(73) Assignee: HYPHONE MACHINE INDUSTRY CO., LTD., Taichung County (TW)

(21) Appl. No.: 12/898,168

(22) Filed: Oct. 5, 2010

(51) Int. Cl. B25F 5/00

(52) U.S. Cl. 173/221; 91/47

(57) ABSTRACT

A pneumatic motor of the present invention is provided for pneumatic tool. The pneumatic motor includes a cylinder, a rotor and a controlling valve. The rotor is rotatably disposed in the cylinder. Two gas passages and an exhaust hole are defined by the cylinder. The exhaust hole extends along a circular direction of the rotor. The exhaust hole has a first end and a second end. The exhaust hole is partially covered by the controlling valve. The exhaust hole has a remained opened portion which is adapted for air to flow therethrough. The controlling valve is adjustable so as to change position of the opened portion. As such, a power stroke in the cylinder is able to be adjusted, so that the power generated by the pneumatic motor is changeable.

### BACKGROUND OF THE INVENTION

1. Field of the Invention

The present invention relates to a pneumatic tool, more particularly to a pneumatic motor for the pneumatic tool.

2. Description of the Prior Art

Pneumatic tool is an instrument which has a tool and a pneumatic motor. The pneumatic motor can drive the tool to rotate. For example, a pneumatic wrench is disclosed in U.S. Pat. No. 5,901,794. The pneumatic motor is driven by pressurized air. Such pneumatic motor usually has an inlet passage and an outlet passage. Pressurized air is led into the inlet passage, driving a rotor of the pneumatic motor to rotate. Pressurized air is released via the outlet passage after driving the rotor to rotate. A power stroke is defined between the inlet passage and the outlet passage. The power stroke is unchanged and is determined by the structure of the pneumatic motor. If user wants to increase the power of the pneumatic motor, the pressure or the flow rate of pressurized air must be increased.

Some pneumatic motors, as shown in TW 1259865 and TW 1325808, have several outlets. Pressurized air can be released to surroundings via one of the outlets. By choosing one of the outlets, the power stroke may be lengthened. As such, the power of the pneumatic may be enlarged.

However, the structures of the pneumatic motors shown in '865 and '808 are complicated. As a result, the cost of the pneumatic motor is high, and the stability and the durability of the pneumatic motor is low.

The present invention is, therefore, arisen to obviate or at least mitigate the above mentioned disadvantages.

### SUMMARY OF THE INVENTION

The main object of the present invention is to provide another pneumatic motor which is able to generate a greater power with a normal pressurized air resource.

To achieve the above and other objects, a pneumatic motor for a pneumatic tool of the present invention includes a cylinder, a rotor and a controlling valve.

A gas space is defined by the cylinder. Two gas passages, an exhaust hole and two axial holes are defined by the cylinder. The axial holes communicate with the gas space. The gas passages, the exhaust hole and at least one of the axial holes communicate between the gas space and surroundings.

The rotor is received in the gas space. The rotor inserts in the axial holes. The rotor is rotatable with respect to the cylinder.

One of the gas passages is adapted for receiving pressurized air so as to lead pressurized air to flow into the gas space. Pressurized air drives the rotor to rotate before pressurized air is released to surroundings via the exhaust hole.

A circular direction is defined about the rotor. The exhaust hole extends along the circular direction. The exhaust hole has a first end and a second end. The gas passages are arranged along the circular direction.

The controlling valve includes a covering piece. The covering piece is movable with respect to the cylinder. The exhaust hole is partially covered by the covering piece, so that the exhaust hole is partitioned into a closed portion and an opened portion. The opened portion is adapted for air to pass therethrough. The covering piece is able to move between a first position and a second position. The opened portion is located at the first end when the covering piece moves to the first position. The opened portion is located at the second end when the covering piece moves to the second position.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a pneumatic tool of the present invention;

FIG. 2 is a partial profile showing a pneumatic tool of the present invention;

FIG. 3 is a partial breakdown drawing showing a pneumatic tool of the present invention;

FIG. 4 is a breakdown drawing showing a pneumatic motor of the present invention;

FIG. 5 is an AA profile of FIG. 4;

FIG. 6 is a profile showing a pneumatic tool of the present invention;

FIG. 7 is a partial perspective drawing showing another embodiment of the present invention;

FIG. 8 is a partial profile showing a pneumatic tool of the present invention.

### DETAILED DESCRIPTION OF THE PREFERRED EMBODIMENTS

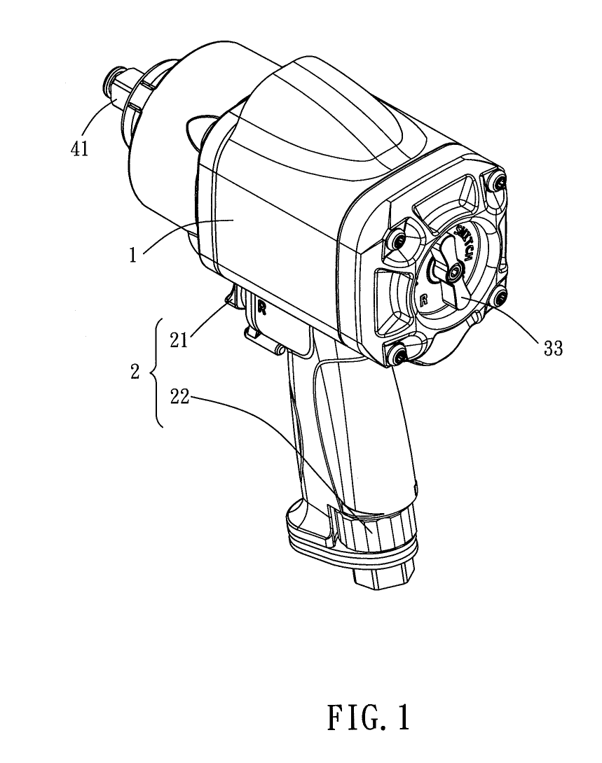

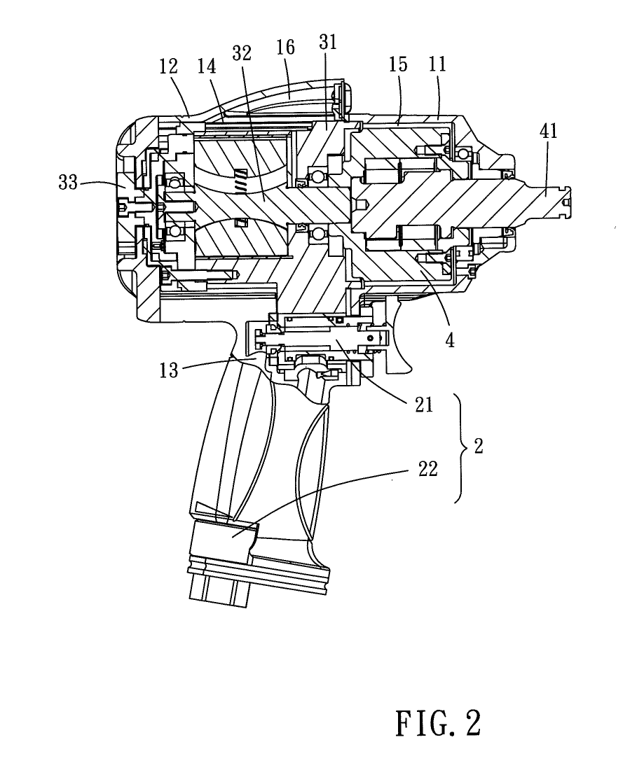

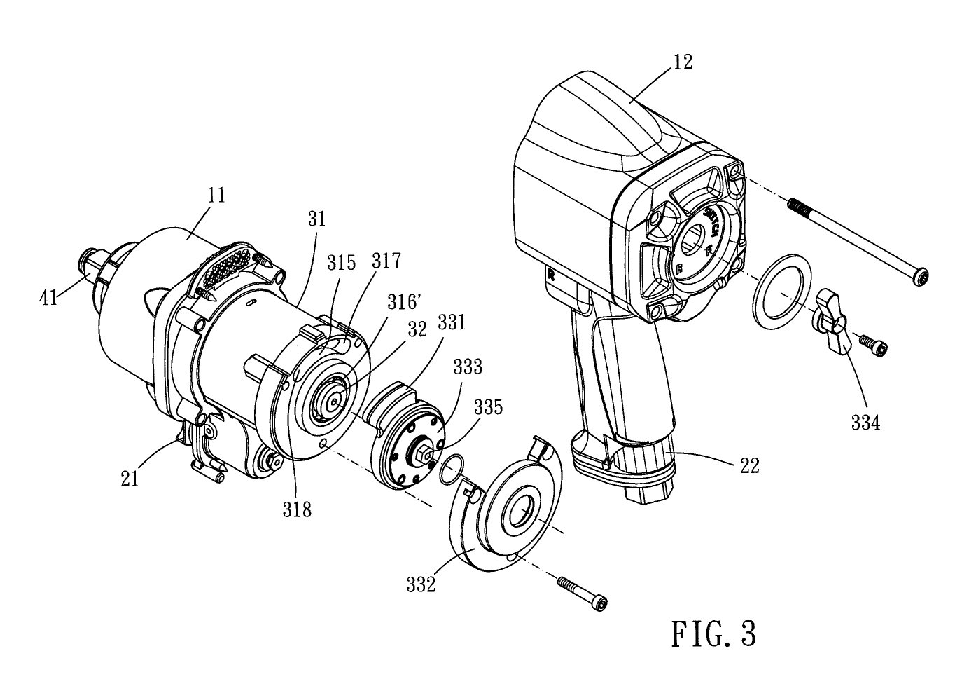

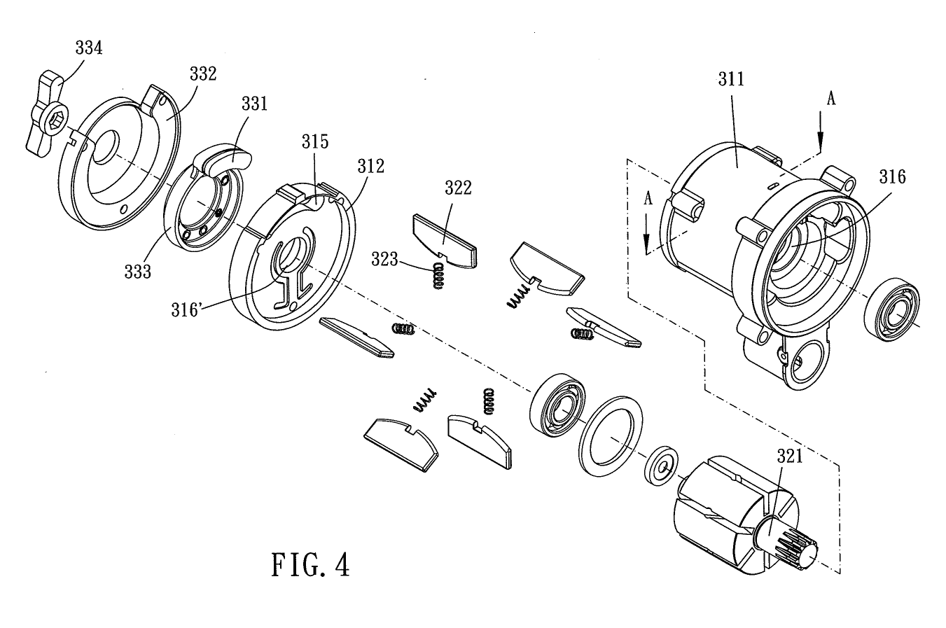

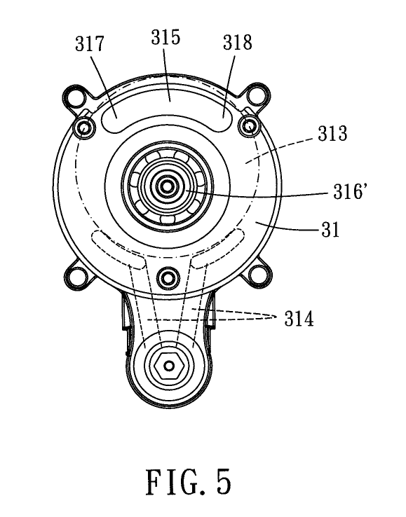

Please refer to FIG. 1 to FIG. 6 for an embodiment of the present invention. The pneumatic tool of the present embodiment includes a shell 1, a gas guiding valve 2, a pneumatic motor and a tool assembly 4.

The shell 1 is a combination of a first shell 11 and a second shell 12. The shell 1 has an inlet 13, a motor containing space 14, a tool containing space 15 and an outlet 16. The motor containing space 14 communicates with the inlet 13 and the tool containing space 15. The outlet 16 communicates between the motor containing space 14 and surroundings. The motor containing space 14 is located between the outlet 16 and the inlet 13.

The gas guiding valve 2 is disposed in the inlet 13. The gas guiding valve 2 is adapted for a pressurized air resource to connect therewith. The gas guiding valve 2 is used to lead pressurized air to flow into the inlet 13. More particularly, the gas guiding valve 2 may include a trigger assembly 21 and a flow rate controlling valve 22.

The pneumatic motor is received in the motor containing space 14. The pneumatic motor is fixed on the shell 1. More specifically, the pneumatic motor includes a cylinder 31, a rotor 32 and a controlling valve 33.

The cylinder 31 may be a combination of a first portion 311 and a second portion 312. The cylinder has a gas space 313, two gas passages 314, an exhaust hole 315 and two axial holes 316. The gas passages 314, the exhaust hole 315 and the axial holes 316, 316′ communicate between the gas space 313 and surroundings. The gas passages 314 are adapted for gas guiding valve 2 to lead pressurized air thereto. The gas guiding valve 2 is able to lead pressurized air to one of the gas passages 314. The exhaust hole 315 communicates with the outlet 16. The axial holes 316, 316′ are coaxial. In other possible embodiments of the present invention, the axial hole 316′ may not penetrate through the cylinder 31. As such, the axial hole 316′ communicates with only the gas space.

The rotor 32 is received in the gas space 313. The rotor 32 inserts in the axial holes 316, 316′, so that the rotor 32 is rotatable with respect to the cylinder 31. The rotor 32 includes a main shaft 321, plurality of blades 322 and plurality of elastic members 323. The quantity of the elastic members 323 is equal to the quantity of the blades 322. The blades 322 and the elastic members 323 are inserted in the main shaft 321, being able to move radially with respect to the main shaft 321. As such, the rotor 32 can be rotated by pressurized air. A circular direction is defined about the rotor 32. In other words, the circular direction extends annularly about the rotor 32. The exhaust hole 315 extends along the circular direction. The exhaust hole 315 has a first end 317 and a second end 318. The gas passages 314 are arranged along the circular direction. After pressurized air is led to one of the gas passages 314, pressurized air is led to the gas space 313 via the gas passage. Pressurized air drives the rotor 32 to rotate before pressurized air is emitted to surroundings via the exhaust hole 315 and the outlet 16.

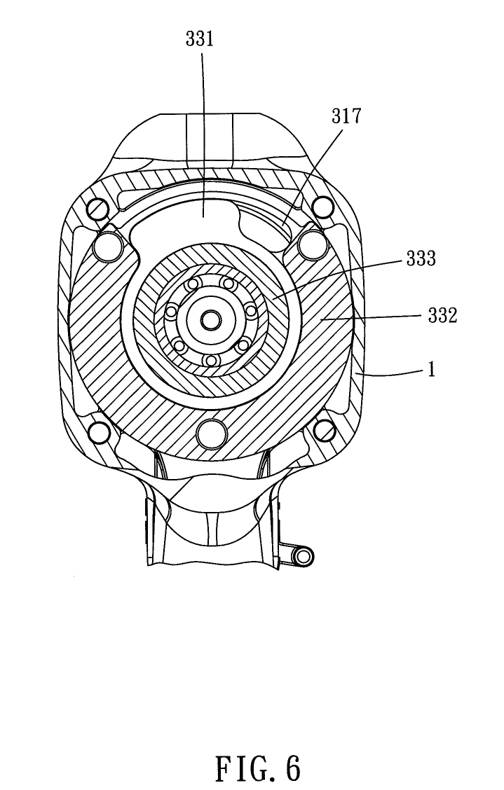

The controlling valve 33 includes a covering piece 331. The covering piece 331 may be smaller than the exhaust hole 315. As such, the exhaust hole 315 can be partially covered by the covering piece 331. The exhaust hole 315 is partitioned into a closed portion and an opened portion by the covering piece 331. The opened portion is adapted for air to pass therethrough. On the contrary, air can not pass through the closed portion. Preferably, the covering piece 331 has a gasket so as to stop air form leaking. The covering piece 331 is movable with respect to the cylinder 31. The covering piece 331 is able to move between a first position and a second position. The opened portion is located at the first end 317 when the covering piece 331 moves to the first position, as shown in FIG. 6. On the contrary, the opened portion is located at the second end 318 when the covering piece 331 moves to the second position.

For moving the covering piece 331, the controlling valve may further include a lid 332, a rotary valve 333 and a rotary switch 334. The lid 332 is firmly disposed on the cylinder 31. The rotary valve 333 is positioned between the lid 332 and the cylinder 31. The rotary valve 333 may have several rotatable balls so as to reduce frictional force between the rotary valve 333 and the lid 332 or the rotary valve 333 and the cylinder 31. The covering piece 331 is firmly disposed on the rotary valve 333. The rotary valve 333 has a shaft 335. An axis is defined by the shaft 335. The rotary valve 333 is able to rotate about the axis. The covering piece 331 moves between the first position and the second position when the rotary valve 333 rotates. The shaft 335 has a non-circular cross-section. The rotary switch 334 is formed with a non-circular hole. The rotary switch 334 is firmly disposed on the shaft 335, so that the rotary switch 334 and the rotary valve 333 are in a rotational operative relationship. As such, the rotary switch 334 can be used to drive the rotary valve 333 to rotate. The covering piece 331 moves between the first position and second position when the rotary valve 333 rotates.

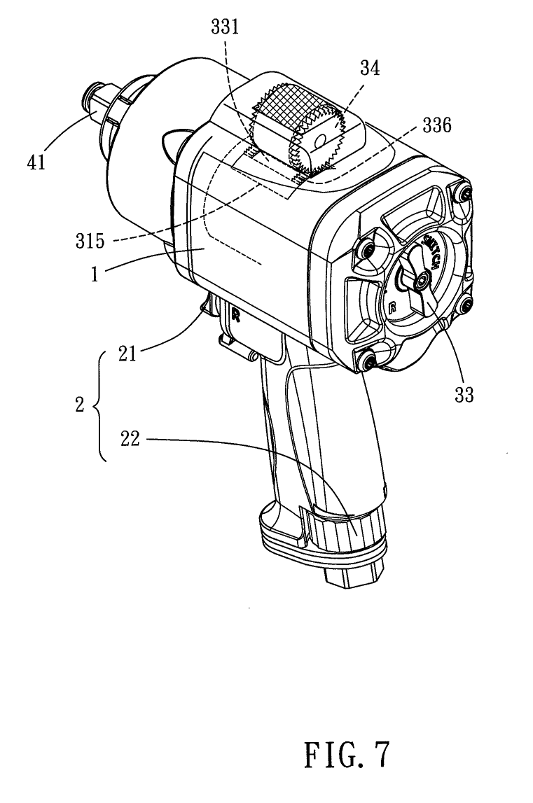

Refer to FIG. 7. In another embodiment of the present invention, the covering piece 331 may be slidably disposed on the cylinder 31. The covering piece 331 is formed with plurality of teeth 336. The teeth 336 are away from the gas space. The pneumatic motor further includes a gear 34. The gear 34 is disposed on the shell 1. The gear 34 has a gear shaft. The gear shaft is disposed on the shell. The gear 34 is able to rotate about the gear shaft. The gear 34 is engaged with the teeth 336. As such, the gear 34 can be twisted. The covering piece 331 moves between the first position and the second position when the gear rotates.

The tool assembly 4 is received in the tool containing space 15. The tool assembly 4 is rotatable with respect to the shell 1. The shell 1 has an opening communicating with the tool containing space 15. The tool assembly 4 has a head portion 41 protruding through the opening of the shell 1. The tool assembly 4 is engaged with the rotor 32 so as to achieve a rotational operative relationship with the rotor. In other possible embodiments of the present invention, the tool assembly may be replaced by other tool assemblies.

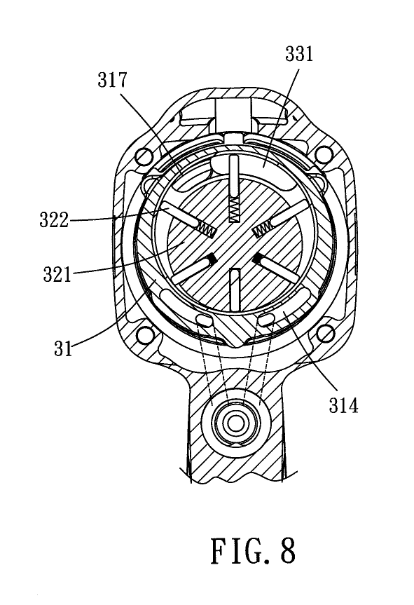

Refer to FIG. 8. Accordingly, the pneumatic tool may be connected with a pressurized air resource. Pressurized air is led to one of the gas passages 314 by the gas guiding valve 2. The pressurized air is led into the gas space 15, driving the rotor 32 to rotate. Finally, pressurized air is emitted to surroundings via the opened portion of the exhaust hole 315 and the outlet 16. The covering piece 331 may be moved to the first position when pressurized air drives the main shaft 321 to rotate counterclockwise. The opened portion is located at the first end 317. The moving distance of pressurized air between the gas passage and the opened portion is lengthened. As such, the power stroke of the pressurized air is lengthened. Power of the pneumatic motor or the pneumatic tool of the present invention is strengthened.

What is claimed is:

1. A pneumatic motor for a pneumatic tool, comprising:
a cylinder, a gas space being defined by the cylinder, two gas passages, an exhaust hole and two axial holes being defined by the cylinder, the axial holes communicating with the gas space, the gas passages, the exhaust hole and at least one of the axial holes communicating between the gas space and surroundings;
a rotor, received in the gas space, the rotor inserting in the axial holes, the rotor being rotatable with respect to the cylinder;
wherein one of the gas passages is adapted for receiving pressurized air so as to lead pressurized air to flow into the gas space, pressurized air drives the rotor to rotate before pressurized air is released to surroundings via the exhaust hole;
wherein a circular direction is defined about the rotor, the exhaust hole extends along the circular direction, the exhaust hole has a first end and a second end, the gas passages are arranged along the circular direction; and
a controlling valve, comprising a covering piece, the covering piece being movable with respect to the cylinder, the exhaust hole being partially covered by the covering piece, so that the exhaust hole is partitioned into a closed portion and an opened portion, the opened portion being adapted for air to pass therethrough, the covering piece being able to move between a first position and a second position, the opened portion being located at the first end when the covering piece moves to the first position, the opened portion being located at the second end when the covering piece moves to the second position.

2. The pneumatic motor of claim 1, wherein the controlling valve further comprises a lid, a rotary valve and a rotary switch, the lid is firmly disposed on the cylinder, the rotary valve is positioned between the lid and the cylinder, the covering piece is firmly disposed on the rotary valve, the rotary valve has a shaft, an axis is defined by the shaft, the rotary valve is able to rotate about the axis, the covering piece moves between the first position and the second position when the rotary valve rotates, the rotary switch is firmly disposed on the shaft so as to achieve a rotational operative relationship with the rotary valve.

3. The pneumatic motor of claim 1, wherein the covering piece is slidably disposed on the cylinder, the covering piece is formed with plurality of teeth away from the gas space, the pneumatic motor further comprises a gear, the gear has a gear shaft, the gear is rotatable about the gear shaft, the gear is engaged with the teeth.

4. A pneumatic tool, comprising the pneumatic motor of claim 1, the pneumatic tool further comprising:
a shell, having an inlet, a motor containing space, a tool containing space and an outlet, the motor containing space communicating with the inlet and the tool containing space, the pneumatic motor being received in the motor containing space, the pneumatic motor being fixed on the shell, the outlet communicating between the exhaust hole and surroundings;
a gas guiding valve, disposed in the inlet, the gas guiding valve being adapted for a pressurized air resource to connect therewith, the gas guiding valve being used to lead pressurized air to flow into one of the gas passages;
a tool assembly, rotatably received in the tool containing space, the tool assembly and the rotor being in a rotational operative relationship.

5. The pneumatic tool of claim 4, wherein the controlling valve further comprises a lid, a rotary valve and a rotary switch, the lid is firmly disposed on the cylinder, the rotary valve is positioned between the lid and the cylinder, the covering piece is firmly disposed on the rotary valve, the rotary valve has a shaft, an axis is defined by the shaft, the rotary valve is able to rotate about the axis, the covering piece moves between the first position and the second position when the rotary valve rotates, the rotary switch is firmly disposed on the shaft so as to achieve a rotational operative relationship with the rotary valve.

6. The pneumatic tool of claim 4, wherein the covering piece is slidably disposed on the cylinder, the covering piece is formed with plurality of teeth away from the gas space, the pneumatic motor further comprises a gear, the gear has a gear shaft, the gear shaft is disposed on the shell, the gear is rotatable about the gear shaft, the gear is engaged with the teeth.
